(19) United States
(12) Patent Application Publication
(10) Pub. No.: US 2011/0296009 A1
(43) Pub. Date: Dec. 1, 2011

(54) SYSTEM AND METHOD FOR WAVELETS-BASED ADAPTIVE MOBILE ADVERTISING FRAUD DETECTION

(76) Inventors: Victor Baranov, Toronto (CA); Grigoriy Melnikov, Tomsk (RU)

(21) Appl. No.: 13/114,269

(22) Filed: May 24, 2011

Related U.S. Application Data
(60) Provisional application No. 61/396,541, filed on May 27, 2010.

(51) Int. Cl. G06F 15/173

(52) U.S. Cl. 709/224

(57) ABSTRACT

In accordance with embodiments, there are provided mechanisms for methods and systems for the detection of fraudulent advertisement views of advertiser supported content on mobile devices through the analysis of data and of data exchange between groups of mobile devices and an advertising server. The data analysis is carried out by comparing statistical data spectra of different mobile device groups to detect unusual levels of advertisement views within a mobile device group. The data analysis provides a high guarantee of fraud detection of illegitimate advertisement views for sponsoring advertisers. Embodiments detect non-meaningful ad display requests or clickthroughs, identify bots among application users and provide an estimate of the number bots.

### CROSS-REFERENCE TO RELATED APPLICATION

The present application claims the benefit of U.S. (Provisional) Application No. 61/396,541, filed May 27, 2010, the contents of which are incorporated herein by reference in their entirety.

### FIELD OF THE INVENTION

The present specification relates to wireless communications. More specifically, the present specification relates to click fraud detection during wireless communications.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Smart phones, which are mobile terminals or mobile devices that combine features of mobile phones and computers, are gaining an increasingly important market share in mobile communications. Ability of the smart phones and other mobile devices to display information and entertainment content or applications on demand has led to rapid development and proliferation of advertiser supported content.

Model for the advertiser supported content for the mobile devices is similar to the advertiser supported content that is found on the Internet. The model for the advertiser supported content provides application developers or content owners with a monetary reward or compensation for user viewership of advertisements that appear with displayed information or entertainment content. User viewership of the advertisements is generally measured by the number of user selections or “clickthroughs” of an advertisement link. The advertisements are positioned on top or bottom of a content page view as a banner, or along sides of the content page. In the event the user selects or clicks on the advertisement link, the user is presented with additional information related to the selected advertisement. The number of users who select or clickthrough on the advertisement is directly related to the effectiveness of the advertisement. Sponsors of the advertisement pay advertising fees or rates that are directly proportional to the effectiveness of the advertisement. For example, the advertisement that attracts a relatively large amount of viewers will command higher advertising rates than the advertisement that attracts a small number of viewers. Therefore, it is in the best interest of content or application providers to supply content to the mobile devices that will attract a high number of viewers that in turn will generate a higher number of clickthroughs on the advertisements that accompany the supplied content.

However, the model for the advertiser supported content has also been subject to fraudulent misuse. For example, if the effectiveness of the advertisement is overstated by the generation of additional clickthroughs that are not legitimately selected by the users, the advertisers will be required to pay for additional advertisement views that have not actually occurred. A common technique to exaggerate the number of advertisement views is through use of bots and botnets.

A bot, which is also known as Internet bots or web robots are software applications that run automated tasks over the Internet. The bots perform tasks that are both simple and structurally repetitive, at a much higher rate than would be possible for a human alone. The bots are a commonly used tool for Internet search engines or web spidering, in which an automated script fetches, analyzes and files information from web servers at many times the speed of a human. While there are many useful and legitimate uses and applications for the bots, the bots may also be used for malicious and fraudulent purposes as well. For example, the bots may be employed to prevent access to web sites by generating a large number of false page views and thereby preventing access to an overwhelmed web server that is hosting the web site. In context of the model for the advertiser supported content, the bots may be used to generate advertisement selections or clickthroughs that have not been initiated by real human viewers of the advertisement. A fraudulent motivation for using the bots would be to increase the collection of advertising fees by a content provider, by generating increased advertisement selections through use of the bots.

A botnet refers to a collection of bots that run autonomously and automatically. The botnets are most commonly associated with malicious software that is hidden from the user.

A botnet's originator can control a group of bots remotely. Furthermore, one of the most efficient and reliable methods implementing click fraud is to create a botnet. The botnet's efficiency is due to the fact that the botnet may completely emulate user actions, thus impeding the botnet's detection.

In light of the foregoing discussion, there is a need for an improved method of detecting and preventing fraudulent activities using bots and botnets, which can overcome one or more drawbacks discussed above.

### SUMMARY

In accordance with embodiments, there are provided mechanisms for fraud detection, and more particularly, for the detection of fraudulent generation of advertisement views of advertiser supported content on mobile terminals and mobile devices. In this specification, the word device may be a user device or terminal, a mobile device or terminal, a mobile phone, a laptop, handheld computer, computer pad (e.g., an iPad®), another mobile device, personal computer, or other device.

Bots used in botnets are continuously being developed, making bot detection increasingly difficult. Therefore, a feature that may be desirable for a fraud protection system is bot detection. It may be desirable that a computer or communication system not only detect the current generation of bots, but also the next generation of bots, so that when a new generation of bots is introduced, the fraud protection system's performance will not be affected. To accomplish lasting fraud protection from the bots, it may be desirable to have mechanisms for fraud protection that are based on principles of adaptability and unpredictability. In addition to or instead of focusing on specific types of bots, mechanisms that do not focus on a certain type of bot is desirable, because bots tend to evolve, thus creating a fraud protection system based only on static or specific types of bots may not be that effective.

Furthermore, while there are existing methods for controlling click fraud in the context of Internet based online banner advertising, the extension of methods for controlling online click fraud to the mobile device market is not effective without taking into account the specifics of the mobile device field. Existing approaches to control click fraud are based on identifying if a user is a bot or not. While checking for the bots may be carried out by several methods, the existing methods of checking for the bots tend to be ineffective against the bots that exceed a given level of protection, and tend to be ineffective for the bots that emulate user behavior completely. In order to detect various cases of botnet-based fraud in the mobile device environment, an accurate analysis of statistical data may be desirable in addition to taking into account the specifics of the mobile advertising field.

Embodiments of the system and method for the detection of fraudulent generation of advertisement views of advertiser supported content on mobile devices provide for the analysis of data and of data exchange between groups of mobile devices and an advertising server. The data analysis is carried out by comparing statistical data spectra of different mobile device groups to detect unusual levels of advertisement views within a particular mobile device group. The data analysis provides a high guarantee of fraud detection of illegitimate advertisement views for sponsoring advertisers. Embodiments may detect non-meaningful ad display requests or clickthroughs, identify bots among application users, and provide an estimate of the number of bots.

In some embodiments, the invention provides a method of fraud detection. The method of fraud detection includes detecting fraudulent requests from a plurality of content display requests and also detecting a source of the fraudulent requests. In an embodiment, the source of the fraudulent request can be a bot or a bot-net and the fraudulent request can be an event of click fraud. In an instance, the content display requests can be requests for advertisement views, wherein the requests for advertisement views are received from a plurality of computing devices, for example mobile devices. The method includes maintaining a database, such that the database includes details of one or more parameters that relate to at least one of the plurality of mobile devices, one or more applications present on the plurality of mobile devices, and the requests for advertisement views. Thereafter, the method includes grouping the plurality of mobile devices into one or more groups, such that each group of the one or more groups includes one or more mobile devices. The one or more mobile devices are characterized such that they share one or more characteristics.

Subsequently, one or more usage trends are generated, the usage trends corresponding to usage of a first application on the one or more groups. The usage trends are based on at least one parameter selected from the one or more parameters. An example of the usage trend includes spectral characteristics of the one or more groups that represent rate of application usage by the one or more groups. Thereafter, each usage trend of the one or more usage trends is compared with at least one other usage trend of the one or more usage trends for identifying the source of the fraudulent requests.

In some embodiments, the invention provides a fraud detection system. The fraud detection system enables detecting fraudulent requests from a plurality of content display requests and also detecting a source of the fraudulent requests. In an instance, the content display requests can be requests for advertisement views, wherein the requests for advertisement views are received from a plurality of computing devices, for example mobile devices. The fraud detection system includes a memory module that includes a database of one or more parameters that relate to at least one of the plurality of mobile devices, one or more applications present on the plurality of mobile devices, and the requests for advertisement views. The fraud detection system also includes a grouping module. The grouping module is configured to group the plurality of mobile devices into one or more groups, such that each group of the one or more groups includes one or more mobile devices. The one or more mobile devices are characterized such that they share one or more characteristics.

The fraud detection system also includes a processor. The processor being configured to generate one or more usage trends, wherein the usage trends correspond to usage of a first application in the one or more groups. The usage trends are based on at least one parameter selected from the one or more parameters. An example of the usage trend includes spectral characteristics of the one or more groups that represent rate of application usage by the one or more groups. The processor is also configured to compare each usage trend of the one or more usage trends with at least one other usage trend of the one or more usage trends for identifying the source of the fraudulent requests.

In another embodiment, the invention provides a computer program product that includes instruction for enabling the method of fraud detection.

Embodiments of the system and method for the detection of fraudulent generation of advertisement views of advertiser supported content on mobile devices are based on statistical methods of data analysis that enable detection of bots from among users in a group by identifying untypical behavior of the bots as compared to other established statistics for the group. In an embodiment, the bots may be identified by dividing mobile device users into groups depending on the characteristics of the mobile devices. For example, a group of users may be formed based on a model or brand of the mobile devices or a version of firmware running on the mobile devices in a particular group (e.g., a group may be formed for Blackberry 8800 mobile terminals, firmware version 4.2.2.176).

In an embodiment, many device parameters are checked for each user, which makes it difficult for bots to emulate the user without detection. The device parameters can be retrieved from hardware, software, and environment settings, etc. Additionally, statistics are cross compared, for instance, if an unusual number of clicks are detected from a particular mobile device type, but similar activities are not detected for other mobile device types, the clicks may be coming from bots.

In an embodiment, the groups are not preset, and the groups are created dynamically. New groups may be created when mobile devices with new features are connected and added to the mobile device network. In embodiments of the fraud detection system and method, it is assumed that there is at least one group not infected by a botnet, which may be used to indicate that the other groups (which have a spectral frequency burst) are infected with botnets. Embodiments of the fraud detection system and method identify the groups infected with bots.

In embodiments, a method for identifying groups with bots is based on a comparison of spectral characteristics of different groups. In the method for identifying groups it is assumed that the spectral characteristics of different groups are similar and characteristics of a particular group are determined and compared to the other groups expected to have the same characteristics and/or characteristics of a particular group are compared to a predetermined set of characteristics for groups of a particular type. In the event that bots appear in a particular group of mobile devices, spectral characteristics (e.g., the frequency characteristics of the number of ad requests) for an infected group will significantly differ from those of uninfected groups. The difference in spectral characteristics may be accompanied by a significant frequency burst, the amplitude of which considerably exceeds the amplitude of a signal originating from the uninfected group (it is assumed that there is little value or motivation to use a small number of bots as it is not economically sound for a perpetrator of fraud).

In embodiments, the spectrums of the groups are plotted using multi-resolution wavelet analysis. Multi-resolution wavelet analysis obtains information on all frequency bursts on different measurement scales (such as different periods of time). The use of varying measurement scales contributes to the detection of botnets with different types of behavior in terms of general statistics. Groups infected with bots are detected by comparing the spectrums of all the groups in a population of the groups on different scales. A burst in the spectrum of one group and the absence of burst in another group may mean that there are bots in the former group. The burst may be bursts in the number of requests to display advertisements. Use of the multi-resolution wavelet analysis may create a universal self-adapting multi-resolution-based system for real-time fraud detection.

An added benefit of use of the embodiments of the method and system for detecting botnets may allow advertising networks to raise price of a click or of a display of an advertisement (and/or other rates) as a result of reducing (and possibly almost completely eliminating) of fraudulent clicks from the bots. Elimination of fraudulent clicks may be represented by a multiplicative probability effect, which is attained by overlapping several results of fraud probability evaluation of various parameters of mobile devices and applications. For instance, if for each of three parameters the probability of fraud detection is 90% (0.9), then in combination the parameters provide fraud detection probability of 1−(1−0.9)̂3=99.9%.

Each embodiment disclosed herein may be used or otherwise combined with any of the other embodiments disclosed. Any element of any embodiment may be used in any embodiment.

Any of the above embodiments may be used alone or together with one another in any combination. The communication methods and systems encompassed within this specification may also include embodiments that are only partially mentioned or alluded to or are not mentioned or alluded to at all in this brief summary or in the abstract.

The aspects, features, techniques and advantages of the present invention described herein are not all-inclusive, and, in particular, many additional aspects, features, techniques and advantages will be apparent to one of ordinary skill in the art in view of the figures and the following description of the preferred embodiments of the present invention.

The foregoing is a summary and thus contains, by necessity, simplifications, generalizations, and omissions of detail. Those skilled in the art will appreciate that the summary is illustrative only and is not intended to be in any way limiting.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is a block diagram of an embodiment illustrating communication between an advertising application, a mobile device and an advertising server with fraud detection features;

FIG. 2 is a flowchart of an embodiment of a method for displaying an advertisement on a mobile device based on a determination of whether an instance of fraud is detected in an advertisement request;

FIG. 3 is a flowchart of an embodiment of a method for fraud detection and analysis;

FIG. 4 is a block diagram of an embodiment illustrating mobile device groups interacting with an advertising server configured with fraud detection features;

FIG. 5 is a flowchart of an embodiment of a method for implementing Real Time Fraud Detection (RFD) component;

FIG. 6 is a flowchart of an embodiment of a method for utilizing a user interest curve to update the RFD component;

FIG. 7 is a flowchart of an embodiment of a method for analyzing the user interest curve for conformance to an adequate interest model for the RFD;

FIG. 8 is a flowchart of an embodiment of a method for checking for an emulator in a mobile device;

FIG. 9 is a flowchart of an embodiment of a method for implementing the Wavelet Fraud Detection (WFD) component;

FIG. 10 is a flowchart of an embodiment of a method for updating the application interest curves for the WFD fraud detection component;

FIG. 11 is a flowchart of an embodiment of a method for analyzing the application interest curve in the WFD component for conformance to the adequate interest model;

FIG. 12 is a block diagram of an embodiment illustrating interaction between the fraud detection module, the database, and the application interface;

FIG. 13 is an embodiment of a chart illustrating a user interest curve with user identification with respect to a unique application instance identifier;

FIG. 14 is an embodiment of a chart illustrating a user interest curve with user identification with respect to a unique mobile terminal identifier;

FIG. 15 is an embodiment of a chart illustrating the number of advertisements displayed based on the user interest curve that is illustrated in the chart of FIG. 13;

FIG. 16 is an embodiment of a chart illustrating the number of advertisements considered fraudulent based on the user interest curve that is illustrated in the chart of FIG. 13;

FIG. 17 is an embodiment of a chart illustrating an application interest curve for a first group;

FIG. 18 is an embodiment of a chart illustrating an application interest curve for a second group;

FIG. 19 is an embodiment of a chart illustrating a time-based wavelet spectrum of the first group;

FIG. 20 is an embodiment of a chart illustrating a time-based wavelet spectrum of the second group;

FIG. 21 is an embodiment demonstrating, through the use of the application interest curve for the second group chart of FIG. 18, the calculation of the number of bots attributed to the second group; and

FIG. 22 shows a block diagram of an embodiment of a device used in this specification.

### DETAILED DESCRIPTION

Although various embodiments of the invention may have been motivated by various deficiencies with the prior art, which may be discussed or alluded to in one or more places in the specification, an embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Before describing the present invention in detail, it should be observed that the present invention utilizes a combination of method steps and apparatus components related to a method of fraud detection. Accordingly the apparatus components and the method steps have been represented where appropriate by conventional symbols in the drawings, showing only specific details that are pertinent for an understanding of the present invention so as not to obscure the disclosure with details that will be readily apparent to those with ordinary skill in the art having the benefit of the description herein.

While the specification concludes with the claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

It will be appreciated that embodiments of the invention described herein may include one or more conventional processors and unique stored program instructions that control the one or more processors to implement, in conjunction with certain non-processor circuits, some, most, or all of the functions of fraud detection described herein. The non-processor circuits may include, but are not limited to, a radio receiver, a radio transmitter, signal drivers, clock circuits, power source circuits, and user input devices. As such, these functions may be interpreted as steps of a method to perform fraud detection. Methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

### GENERAL DEFINITIONS

Fraud, Click fraud—fraudulent clicks on ads of a contextual advertising systems resulting in charges to an advertiser.

Computing device (Mobile Device)—a device with an installed advertising application and access to an advertising server.

Advertising server—a server that provides ads to an advertising application installed for display on a mobile device. An advertiser or sponsor pays the relevant application developer for each ad display on a mobile device.

Developer—a publisher of an advertising application.

User—a person who is not a bot and who uses an advertising application on a mobile device.

Group—users of one and the same application, whose mobile devices have similar characteristics such as, for instance: model, software version, geographic location, Internet provider, and other similar features characteristic of a group of mobile devices.

Bot—a software program emulating the use of a mobile device by the user. A bot may be used for click fraud.

Botnet—a set of bots that may be used for implementing click fraud.

Content display request/Advertisement display request (advertising request, click-through, click)—an action taken by a user or a bot and considered by the server as an event for which an advertiser or sponsor is required to pay.

Usage trend (for example, Interest curve)—a discrete function of time describing the history of a user's or group's requests coming from a mobile device or an advertising application. An interest curve is denoted as follows: I[t], t={tᵢ}, i= 0̅ .̅ .̅ .̅ N̅−̅1̅, where tᵢ is the time interval number i, N is the total number of time intervals (the number of discrete function values).

Base device trend (for example, Normalized interest curve)—let I[tᵢ], i= 0̅ .̅ .̅ .̅ N̅−̅1̅ be an interest curve, then a normalized curve is denoted as Ī[tᵢ], i= 0̅ .̅ .̅ .̅ N̅−̅1̅, and is calculated as follows:

$$\overline{I} [ {t}_{i} ] = \frac{I [ {t}_{i} ]}{avg} , i = \overline{0 … N - 1} ,$$

where

$$avg = \frac{1}{N} {\sum }_{i = 0}^{N - 1} I [ {t}_{i} ] .$$

Spectrum—coefficients obtained after passing of a discrete signal through a high-pass filter. Let I[tᵢ] i= 0̅ .̅ .̅ .̅ N̅−̅1̅ be an interest curve, the interest curve's spectrum may be denoted as D(I)[tᵢ], i= 0̅ .̅ .̅ .̅ N̅−̅1̅. If ψ={ψᵢ}ᵢ₌₀^{2*K+1} represents a digital high-pass filter with coefficients ψᵢ, then the spectrum is defined by the following convolution:

$$D ( I ) [ {t}_{i} ] = {\sum }_{i = - K}^{K} {ψ}_{i} I [ {t}_{j + i} ] ,$$

j= 0̅ .̅ .̅ .̅ N̅−̅1̅, if j+i<0, then I[tⱼ₊ᵢ]=I[t₀], if j+i≧N, then I[t_{j+1]=I[t}_{N-1}].

Multiresolution analysis—is the analysis of a signal based on multiresolution wavelet analysis—where a signal is divided by high-pass and low-pass filters into two components—a smooth component (low frequency) and a detailed component (high frequency). The principle of multiresolution analysis is that the smooth component may be passed again through the high-pass and low-pass filters, thus providing frequency characteristics of the signal on a given scale.

The notation ρ(x, y) represents a function that is a metric of distance between two discrete functions x[tᵢ], y[tᵢ] i= 0̅ .̅ .̅ .̅ N̅−̅1̅. In the present disclosure, any of the following functions may be regarded as examples of ρ(x, y):

Root-mean-square deviation metric:

$$ρ ( x , y ) = \frac{1}{N} {\sum }_{i} {\vert x [ {t}_{i} ] - y [ {t}_{i} ] \vert}^{2} ;$$

maximum metric:

$$ρ ( x , y ) = {MAX}_{i} ( \vert x [ {t}_{i} ] - y [ {t}_{i} ] \vert ) ;$$

Adequate interest model for an application—is a model describing the trend of a group's interest in an application. The adequate interest model is based on the following assumption: a group's interest in an application has some common characteristics, regardless of the mobile device used, the device's location, Internet provider, mobile service provider or carrier, and other similar characteristics typical of a range of mobile device users. Let M be the number of groups, IGₖ[t] is an application interest curve plotted according to the k-th group, k= 0̅ .̅ .̅ .̅ M̅−̅. Let I̅G̅ₖ[t]: IGₖ[t]→ I̅G̅ₖ[t] be a normalized curve of IGₖ[t]. Let ε>0 (preset value characterizing the similarity of interest curves), let D( I̅G̅ₖ)[t] be the spectrum of the k-th curve, then if p(D( I̅G̅ᵢ)[t], D( I̅G̅ⱼ)[t])<ε∀i, j= 0̅ .̅ .̅ .̅ M̅−̅1̅, then the application is considered to conform to the adequate interest model. If there is a variable ∃j , that ρ(D( I̅G̅ᵢ)[t], D( I̅G̅ⱼ)[t])≧ε, ∀i, j= 0̅ .̅ .̅ .̅ M̅−̅1̅, i≠j, then it is assumed that interest curve IGⱼ[t] does not conform to the adequate interest model, and the application does not conform to the adequate interest model for the application.

Adequate interest model for a user—is a model describing the trend of an advertising application used by a user. The adequate interestmodel assumes that there is no reason for the user to use the application exceedingly often. Let I[tᵢ] i= 0̅ .̅ .̅ .̅ N̅−̅1̅, be a user interest curve. It is assumed that interest curve I[t] conforms to the adequate interest model, if the following conditions are met:

$$1. {MAX}_{i} ( I [ {t}_{i} ] ) < ɛ 1 ;$$

$$2. {\sum }_{i} I [ {t}_{i} ] < ɛ 2 ;$$

where ε1 is the maximum possible number of ad display requests per time unit, ε2 is the maximum possible number of ad display requests for the whole period t={tᵢ}_{i=0 . . . N-1}.

RFD(Real-time Fraud Detection)—is a component for the real-time detection of fraud coming from individual users or bots.

WFD (Wavelets-based Fraud Detection)—is a botnet detection component.

The invention provides a method of fraud detection, a computer program product including instructions for enabling the method of fraud detection and a fraud detection system. The invention enables detecting fraudulent requests from a plurality of content display requests and also enables detecting a source of the fraudulent requests. Examples of the content display requests according to the invention include advertisement display requests. In an instance, the content display requests can be requests for advertisement views. These requests for advertisement views are received from a plurality of computing devices. Examples of which include, but are not limited to a mobile device, a personal computer, a workstation, a laptop, a game console, a handheld network enabled audio/video player and a personal digital assistant. For easier understanding, the invention will be described in terms of an advertisement display request and mobile devices.

The invention includes maintaining a database, such that the database includes details of one or more parameters that relate to at least one of the plurality of mobile devices, one or more applications present on the plurality of mobile devices, and the requests for advertisement views. This database is stored in a memory of the fraud detection system of the invention.

The invention also includes grouping the plurality of mobile devices into one or more groups, such that each group of the one or more groups includes one or more mobile devices. The one or more mobile devices are characterized such that they share one or more characteristics. The grouping of the mobile devices is carried out by a grouping module of the fraud detection system.

The invention further includes generation of one or more usage trends. The usage trends can be represented in the form of interest curves defined earlier. For easier understanding the invention will be described in respect to interest curves. The interest curves correspond to usage of a first application in the one or more groups. The interest curves are based on at least one parameter selected from the one or more parameters and in an instance include spectral characteristics of the one or more groups that represent rate of application usage by the one or more groups. Thereafter, each usage trend of the one or more interest curves is compared with at least one other interest curves of the one or more interest curves for identifying the source of the fraudulent requests. This generation of interest curves and comparison of the interest curves is carried out using a processor of the fraud detection system,

The invention also includes generation of one or more device trends corresponding to the one or more characteristics of the mobile device. In an instance, the one or more device trends can be a user interest curve. According to the invention, the user interest curve is compared against a base device trend generated corresponding to the one or more characteristics and to identify a fraudulent mobile device.

In accordance with embodiments, there are provided mechanisms for methods and systems for the detection of fraudulent advertisement views of advertiser supported content on mobile devices through the analysis of data and of data exchange between groups of mobile devices and an advertising server. The data analysis is carried out by comparing statistical data spectra of different mobile device groups to detect unusual levels of advertisement views within a mobile device group. The data analysis provides a high guarantee of fraud detection of illegitimate advertisement views for sponsoring advertisers. Embodiments detect non-meaningful ad display requests or clickthroughs, identify bots among application users and provide an estimate of the number bots.

Embodiments of the system and method for the detection of fraudulent generation of advertisement views of advertiser supported content on mobile devices is based on statistical methods of data analysis that enable the detection of bots from among users in a group by the identifying untypical behavior of bots as compared to other established statistics for the group. Bots are identified by dividing mobile device users into groups depending on the characteristics of the mobile devices. For example, a group of users may be formed based on a model or brand of mobile device, or version of firmware running the devices in a particular group. Groups are not preset, and the groups are created dynamically. New groups may be created when devices with new features are connected and added to the mobile device network. In embodiments of the fraud detection system and method, it is assumed that there is at least one group not covered by a botnet. Embodiments of the fraud detection system and method identify groups infected with bots.

In embodiments, a method for identifying groups with bots is based on a comparison of spectral characteristics of different groups. In the method it is assumed that spectral characteristics of different groups are similar. In the event bots appear in a particular group of mobile devices, spectral characteristics for the infected group will significantly differ from those of uninfected groups. The difference in spectral characteristics will be accompanied by a significant frequency burst, the amplitude of which considerably exceeds the amplitude of a signal originating from an uninfected group (it is assumed that there is little value or motivation to use a small number of bots—it is not economically sound for a perpetrator of fraud).

In embodiments, the spectrum of groups is plotted using multi-resolution wavelet analysis. Multi-resolution wavelet analysis obtains information on all frequency bursts on different measurement scales (such as different periods of time). The use of varying measurement scales contributes to the detection of botnets with different types of behavior in terms of general statistics. Groups infected with bots are detected by comparing the spectra of all groups in the whole population of groups on these different scales. A burst in the spectrum of one group and the absence of the burst (e.g., advertising requests) in that of another group may mean there are bots in the former group. The use of multi-resolution wavelet analysis creates a universal self-adapting multi-resolution-based system for real-time fraud detection.

In embodiments, a system is made up of a number of users, each of the users having a mobile device with an advertising application installed that may communicate with an advertising server. In an embodiment, bots may also appear to the advertising server as a user. In the event an advertising application is started, the application calls an advertising server which registers the request and provides ads for display on the mobile device whose advertising application contacted the server. A fraud detection component, which may be part of the advertising server is used to detect bots among users (of a specific advertising application), if any, and estimate the number of bots encountered. The detection of bots is accomplished by dividing users into groups and analyzing spectral characteristics of each of the groups.

In embodiments, interest curves for each user and application are plotted in the process of communication between the advertising server and the advertising application installed on the user's mobile devices. In the event a user interest curve does not conform to an adequate interest model, an assumption is made that there are non-meaningful advertisement requests. The non-meaningful advertisement requests are assumed to be fraudulent and are ignored, and the advertiser or sponsor is not charged. If the application interest curve does not conform to the adequate interest model, it is assumed that there are bots among the users. In this case, requests from all instances of the advertising applications are ignored.

Advertising Application, Mobile Device, and Advertising Server

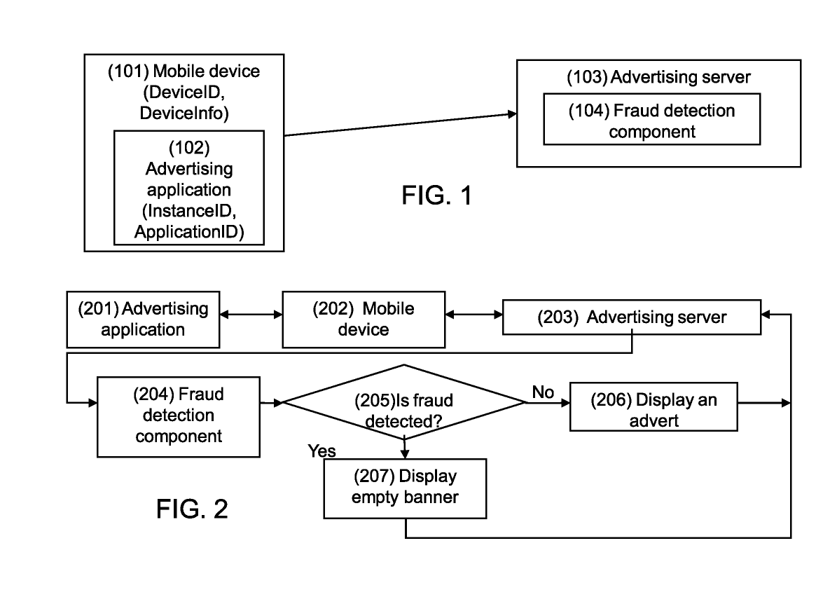

FIG. 1 is a bock diagram of an embodiment illustrating communication between an application, for example an advertising application, a computing device, for example a mobile device and a fraud detection system, for example an advertising server with fraud detection features. In an embodiment, the advertising application is installed on the mobile device. For the purpose of the description, the FIG. 1 has been shown to include only those components that are pertinent to the description of the invention. However, it should be understood that the invention is not limited to the components listed above. In some cases, additional components may be present to enhance efficiency or to improve reliability, without deviating from the scope of the invention.

The installed advertising application on the mobile device may include a unique instance identifier (InstanceID), an application identifier (ApplicationID), and an identifier of the application developer (DeveloperID).

The mobile device includes one or more characteristics defining the mobile device (DeviceInfo—a structure comprising detailed information on the mobile device), and a unique device identifier (DeviceID). Other examples of the one or more characteristics include, but are not limited to, a unique identifier of a CPU of the mobile device, a unique identifier of a memory card used in the mobile device, an IMEI number of the mobile device, an IMSI number of the mobile device, one or more software component of the mobile device, a geographic location of the mobile device, and an internet provider of the mobile device. During interaction between the mobile device and the advertising server, the advertising server is sent the one or more characteristics that identify the advertising application installed on the mobile device.

Interaction Between an Advertising Application, a Server, and a Fraud Detection System

FIG. 2 is a flowchart of an embodiment of a method for displaying an advertisement on a mobile device based on a determination of whether an instance of fraud is detected in a content display request, for example the advertisement display request. In FIG. 2, a mobile device (202) sends an ad display request with a data packet including one or more parameters identifying the mobile device (202) and the advertising application (201). At the advertising server (203), the data packet is processed by the fraud detection system (204), and a decision on fraud presence or absence is immediately made. In the event the ad request is determined to be legitimate, the requested advertisement is displayed on the mobile device. In the event a fraudulent advertisement request is detected, an empty banner may be displayed on the mobile device. Examples of the one or more parameters include, but are not limited to, a unique identifier of a CPU of the mobile device, a unique identifier of a memory card used in the mobile device, an IMEI number of the mobile device, an IMSI number of the mobile device, one or more software component of the mobile device, a geographic location of the mobile device, an internet provider of the mobile device and a unique identifier of an application. In an embodiment, the advertising application is installed on the mobile device.

For the purpose of the description, FIG. 2 has been shown to include only those components that are pertinent to the description of the invention. However, it should be understood that the invention is not limited to the components listed above. In some cases, additional components may be present to enhance efficiency or to improve reliability, without deviating from the scope of the invention.

Structure and Method of the Fraud Detection System

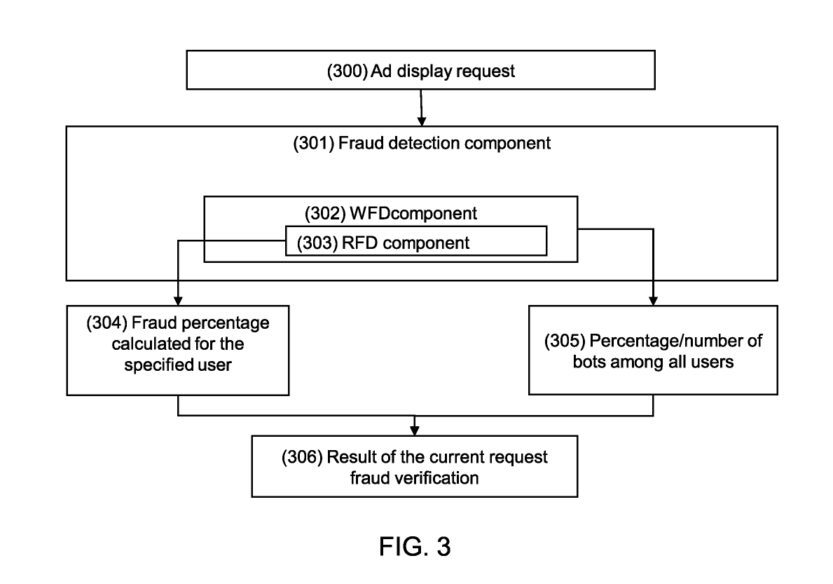

FIG. 3 is a flowchart of an embodiment of a method for fraud detection and analysis. In FIG. 3, the fraud detection module or component (301) receives an incoming ad display request (300) from an advertising application on a mobile device. The output from the fraud detection module (301) is an indication of the results of fraud verification of the ad display request (306). The fraud detection module (301) includes the Wavelets-based Fraud Detection (WFD) (302) and Real-time Fraud Detection (RFD) (303) components. A purpose of the RFD component is to detect fraud coming from individual bots, emulators, or users. A task of the RFD component is to check a user interest curve for conformity to an adequate interest model. A purpose of the WFD component is to detect botnets. A task of the WFD component is to analyze an application interest curve for conformity to the adequate interest model. The output of RFD and WFD components is the percentage distribution of fraud amount in time (304) and the number of bots among users for each application (305). It will be apparent to those skilled in the art that the user interest curve and the application interest curve can be any other usage trend represented by spectral characteristics of the user or application usage respectively.

For the purpose of the description, FIG. 3 has been shown to include only those steps that are pertinent to the description of the invention. However, it should be understood that the invention is not limited to the steps listed above. In some cases, additional or lesser steps may be present to enhance efficiency or to improve reliability, without deviating from the scope of the invention.

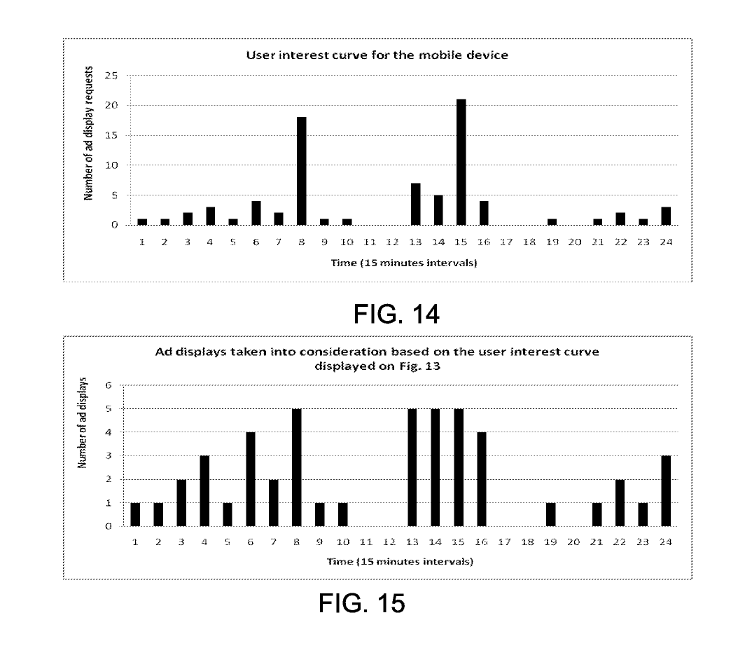

In embodiments, the RFD component has at least two functions: an emulator check of a mobile device, and the analysis of user interest curves for conformity to the adequate interest model. The emulator check is carried out by comparing user interest curves plotted based on various unique identifiers of the used mobile device. If interest curves do not match, the mobile device is considered an emulator. If the mobile terminal is not an emulator, the interest curves are analyzed for conformity to the adequate interest model. FIGS. 13 and 14 illustrate examples of interest curves plotted based on the unique identifier of the mobile terminal and the unique identifier of the application instance. A mobile terminal interest curve has high energy, as it describes the rate of device usage as a whole, not a single application.

Performance Flow Chart of the RFD Component

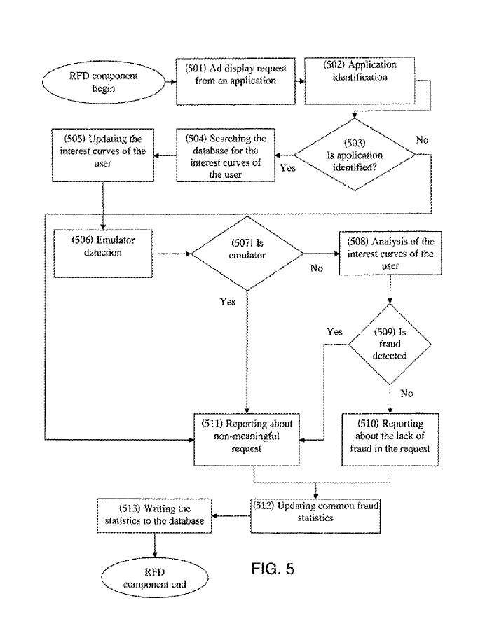

FIG. 5 is a flowchart of an embodiment of a method for implementing the RFD fraud detection component, which is a part of the fraud detection system of the invention. The RFD fraud detection component may perform the following:

a. Advertising application identification by a unique instance identifier (502) may be checked for. When an advertising application is installed on a mobile device, the advertising server assigns a unique instance identifier to the application. If a unique instance identifier exists, the application is identified; otherwise the application is not identified.

b. An emulator check of a mobile device (506) may be performed to determine whether the detected mobile device is an emulator.

c. User interest curves (505) may be updated. The RFD component plots at least two interest curves: in the first interest curve, the user is identified by a unique identifier of the advertising application instance, and in the second interest curve the user is identified by the unique identifier of the mobile terminal. Upon receiving the next ad display request, the interest curves are updated.

d. The user interest curves may be checked for conformity to the adequate interest model (508).

e. The fraud statistics (512) may be updated and the updates may be saved to the database (513). Ad display requests are accumulated and classified by fraud type. All of the above data may stored in a database, which provides the possibility of determining fraud occurrences in real time by comparing the current statistics to the statistics stored in the database.

Examples of one or more characteristics used to plot the user interest curves are selected from the one or more parameters, and include, but are not limited to, a unique identifier of a CPU of the mobile device, a unique identifier of a memory card used in the mobile device, an IMEI number of the mobile device, an IMSI number of the mobile device, one or more software component of the mobile device, a geographic location of the mobile device, and an internet provider of the mobile device.

It should be appreciated that the method described in FIG. 5 is not limited to the number of steps listed above. In some cases, the method may include more or less number of steps, without deviating from the scope of the invention.

Method for User Interest Curve Plotting

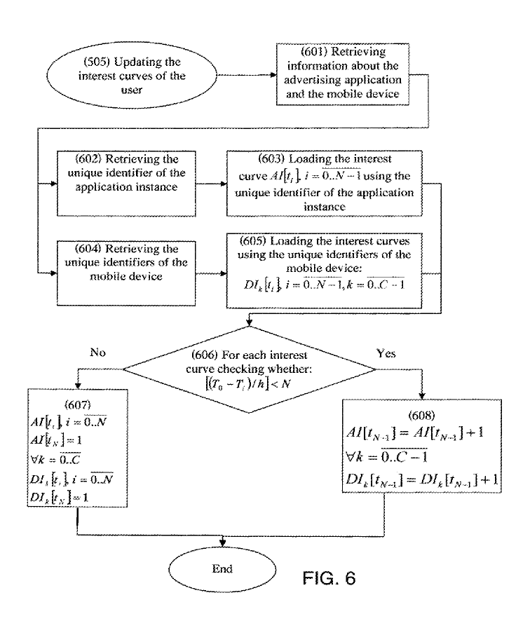

FIG. 6 is a flowchart of an embodiment of a method for utilizing a user interest curve to update the RFD component. In embodiments, a plurality of interest curves are plotted for a user. One curve is plotted using the unique application instance identifier. All other curves may be plotted using unique identifiers of the mobile device. In an event the RFD component deals with a real device and not a bot, the interest curves based on the different unique identifiers will coincide. Upon receiving an ad display request, all interest curves are updated. Unique identifiers of the mobile terminal and of the advertising application instance, (602) and (604) respectively, are retrieved from the ad display request. Based on the unique identifiers data, interest curves (603), (605) of the current user are searched for and updated. In FIG. 6, AI[t], DIₖ[t], k= 0̅ .̅ .̅ .̅ C̅−̅1̅ illustrates interest curves of the application and the device respectively, where C is the number of interest curves plotted using unique identifiers of the mobile terminal. Disclosed in an embodiment below is the process updating an interest curve. If I[tᵢ], i= 0̅ .̅ .̅ .̅ N̅−̅1̅ is an interest curve, then I[tₙ] denotes the number of ad display requests in a time period tₙ, where N is the number of time periods. Let T₀ be the time of the first ad display request, Tᵢ—the time of the current request, h—value of a time interval; then if [(T₀−Tᵢ)/h]<N (the integer part), the last value of the interest curve is incremented: I[t_{N-1}]=I[t_{N-1}]+1, otherwise, “extension” by 1 value takes place I[tᵢ], i= 0̅ .̅ .̅ .̅ N̅−̅1̅: I[t_{N}]=1. Adding 1 to I[t] adds one time unit to I[t], and setting I[tN] to equal 1 when [(T₀−Tᵢ/h]≧N essentially states that only one reliable display ad request has occurred, because too many display ad requests have occurred for the display ad request to have been from a real user.

Emulator Check of a Mobile Terminal

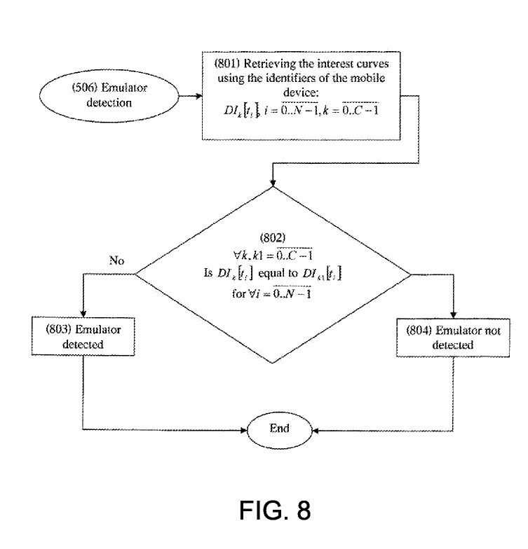

FIG. 8 is a flowchart of an embodiment of a method for checking for an emulator in a mobile device.

A mobile terminal may be identified by a number of unique identifiers (such as International Mobile Equipment Identity (IMEI), International Mobile Subscriber Identity (IMSI), serial number of a CPU or memory, etc.—or any identifier that is unique). The unique identifiers include the DeviceInfo structure (FIG. 1). A user interest curve is plotted using each of the unique identifiers, as described in the preceding paragraph. In FIG. 8, DIₖ[tᵢ], t= 0̅ .̅ .̅ .̅ N̅−̅1̅, k= 0̅ .̅ .̅ .̅ C̅−̅1̅ are the user interest curves plotted using each identifier, C is the number of interest curves. If the interest curves of the same mobile device plotted according to different identifiers do not match (802), the terminal is considered an emulator. Since the signals were received from the same device (and presumably the same single user), a self consistency check may be performed for each click or request for displaying an ad. Each click info from a device may be carrying, for example, an IMEI and a firmware version. If a click contains valid firmware, but an invalid IMEI (e.g., the botnet authors decided to put some random numbers or zeros into this field because the botnet authors did not have time to find out the range of valid IMEI numbers for this category of devices), such a click cannot possibly come from a real device. In addition, an emulator check may be carried out in a standard way—through a software interface of the mobile device.

User Interest Curve Analysis

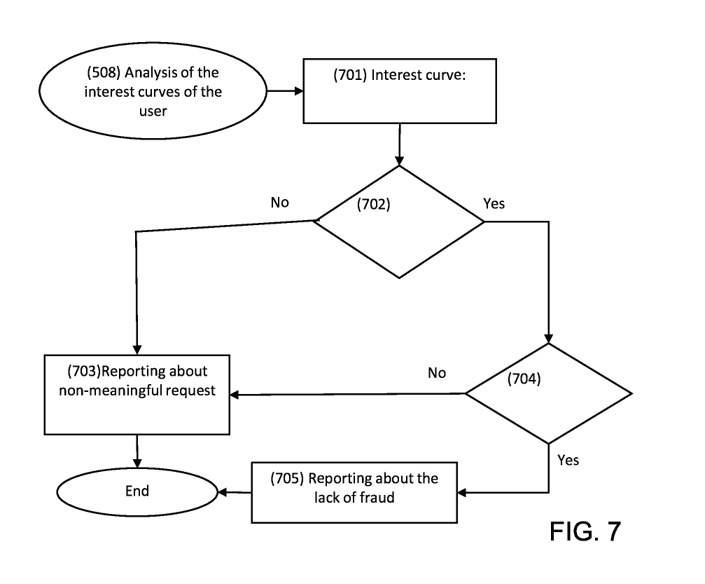

FIG. 7 is a flowchart of an embodiment of a method for analyzing the user interest curve for conformance to an adequate interest model for the RFD. Let I[tᵢ], i= 0̅ .̅ .̅ .̅ N̅−̅1̅(701) be an interest curve, ε1—the maximum possible number of ad display requests per time unit, ε2—the maximum possible number of ad display requests for the whole period. Then, if the following conditions are met:

$${\sum }_{i} ( I [ {t}_{i} ] ) < ɛ 1 and {MAX}_{i} ( I [ {t}_{i} ] ) < ɛ 2 ,$$

the interest curve conforms to the adequate interest model. If I[t_{N-1}]≧ε2 (702) then the last request is considered a non-meaningful request (703) and the last request is ignored (the ad requested is not displayed).

Updating General Fraud Statistics for the RFD Component

In embodiments, the RFD component records the statistics of the total number of requests and the number of requests that are regarded as fraudulent for each application and the developer of the application. Request statistics may be stored in a database in the form of a function of time as a function that gives the amount of fraudulent events during a given time or the distribution of fraudulent events during a given time period. In an embodiment, the database is maintained in the memory of the fraud detection system.

Principle of Operation of an Embodiment of the WFD Fraud Detection Component

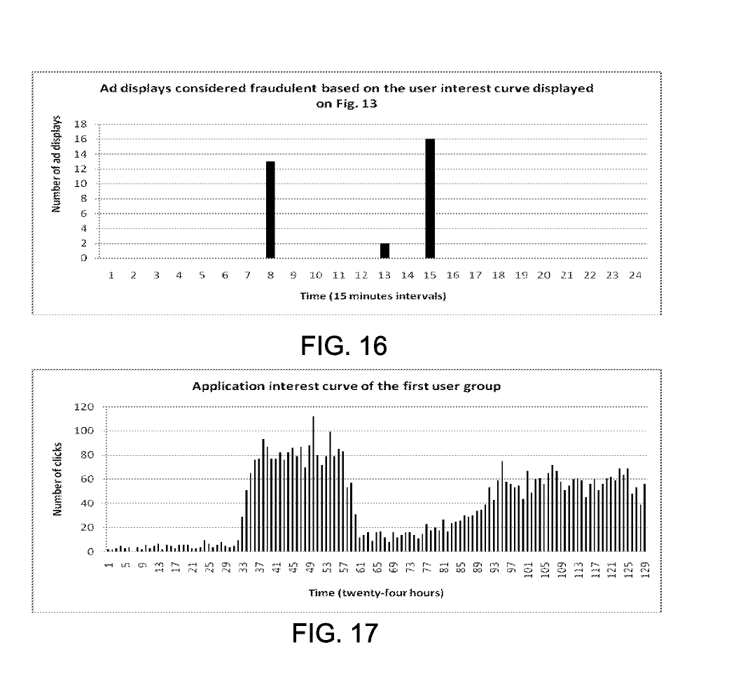

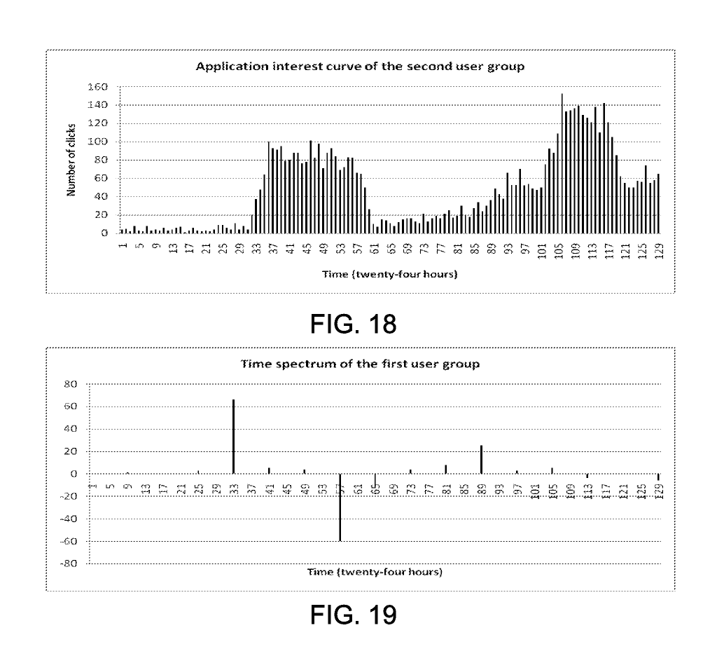

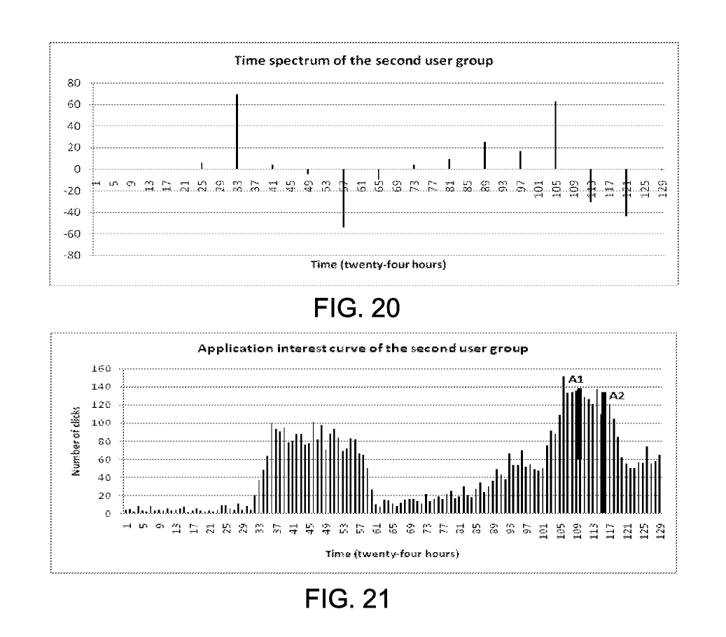

Embodiments of the WFD component are used to detect a botnet (or botnet emulator) that fully emulates a group's actions. Botnets are detected by comparing spectral characteristics of various groups' interest curves. It is assumed that a botnet does not cover all possible groups. FIGS. 17 and 18 illustrate application interest curves for different groups. Analysis of the frequency spectrum of these curves (FIGS. 19 and 20) shows a significant frequency burst in the second group which is absent in the first group (interval between the 100 and 120 time periods). Therefore, it is assumed that there may be a botnet in the second group.

Flow Chart of the WFD Fraud Detection Component

FIG. 9 is a flowchart of an embodiment of a method for implementing the WFD fraud detection component. The method for implementing the WFD component includes the following:

a. The RFD fraud detection component (902). The RFD fraud detection component is essential for the detection of fraud so that application interest curves do not contain RFD fraud, and the application interest curves reflect the real trend of the group's interest in the application.

b. A component for application interest curves plotting for each group (904). Upon receiving an ad display request, the user is identified, the groups he/she belongs to are defined, and the interest curves of these groups are updated.

c. A component for interest curves analysis for conformity to the adequate interest model for an application (905). At this step, the spectra of all groups' interest curves are plotted and compared to each other on different scales. In other words, the wavelet method may provide a multiresolution analysis. For instance, a one-hour long time window, a one-day-long window, or one-month-long window of a curve may be inspected. When analyzing one month-long statistics, the small anomalies that could be happening at 1-hour-long time scale may not be apparent, because the smaller anomalies may have been smoothed out. When viewing a one-hour-long sample of a curve, the anomalies over a short time period may be apparent, the anomalies that are occur over a long time period may not be apparent. For example, the short time one hour periods may not give the “complete picture” within a one month window. Wavelets provide multiple views on multiple scales, so anomalies of many forms can be detected. A group with an interest curve spectrum significantly different from other groups' spectra is considered the most likely to have a botnet.

d. A component for computing the number of bots among the users (910). The number of bots among the users may be calculated by analyzing the group's interest curve that does not conform to the adequate interest model.

Examples of one or more parameters used to plot the application interest curves for one or more groups include, but are not limited to, a unique identifier of a CPU of the mobile device, a unique identifier of a memory card used in the mobile device, an IMEI number of the mobile device, an IMSI number of the mobile device, one or more software component of the mobile device, a geographic location of the mobile device, an internet provider of the mobile device, and a unique identified of the application running on the mobile device.

It should be appreciated that the method described in FIG. 9 is not limited to the number of steps listed above. In some cases, the method may include more or less number of steps, without deviating from the scope of the invention.

Plotting of Application Interest Curves

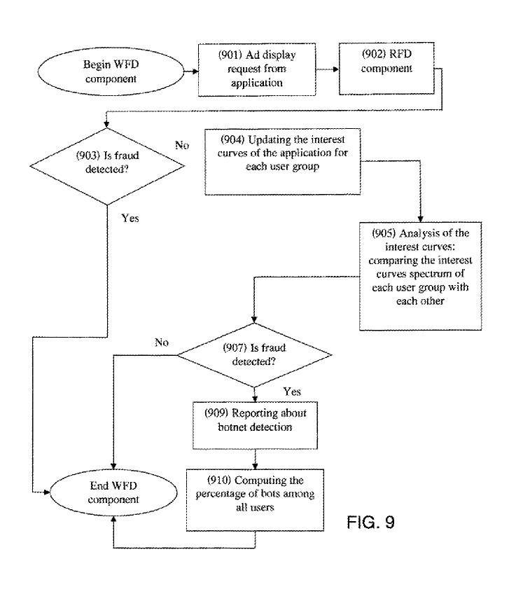

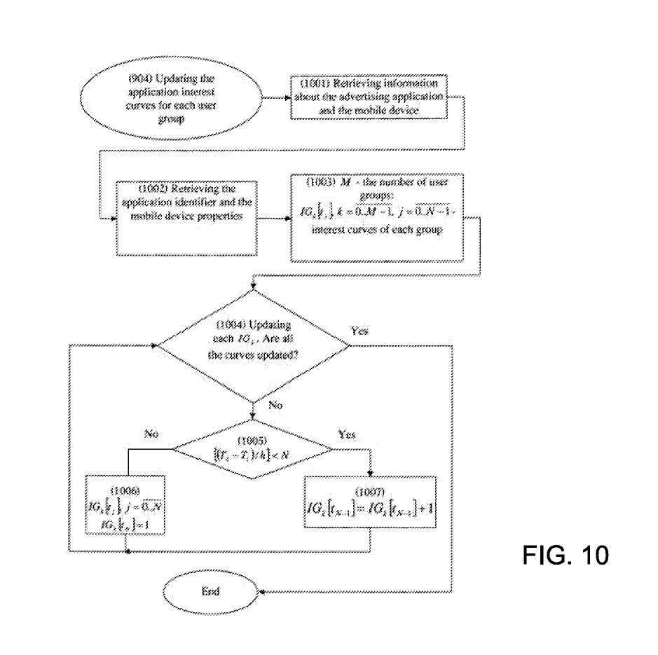

FIG. 10 is a flowchart of an embodiment of a method for updating the application interest curves for the WFD fraud detection component. In embodiments, all users of the advertising application are divided into groups according to the characteristics of their mobile devices. In an embodiment of the present invention, this grouping can be carried out by a grouping module of the fraud detection system. Upon receiving an ad display request, the user is identified according to which groups the user belongs. Interest curves of the groups are updated. Let IGₖ[tⱼ], k= 0̅ .̅ .̅ .̅ M̅−̅1̅, j= 0̅ .̅ .̅ .̅ N̅−̅1̅ be the interest curves of all groups of application users, M is the number of groups, N is the number of time slots of the interest curves. Upon receiving of an ad display request (1001), the user is identified (1002), and is identified as belonging to one or several defined groups (1003). In an embodiment, only the interest curves of those groups where the user belongs are updated (1004). To update the interest curve IGₖ[t], the value [(T₀−Tᵢ)/h] is calculated (the integer part), where T₀ is the time of the first ad display request from an application, Tᵢ is the time of the current request, h is the time period. If [(T₀−Tᵢ)/h]<N, then the value of the interest curve at point t_{N-1}−IGₖ[t_{N-1}] is incremented: IGₖ[t_{N-1}]=IGₖ[t_{N-1}]+1, otherwise the interest curve is extended IGₖ[t_{N}]=1

Analysis of Application Interest Curves; Application Interest Curves are Analyzed for Conformity to the Adequate Interest Model

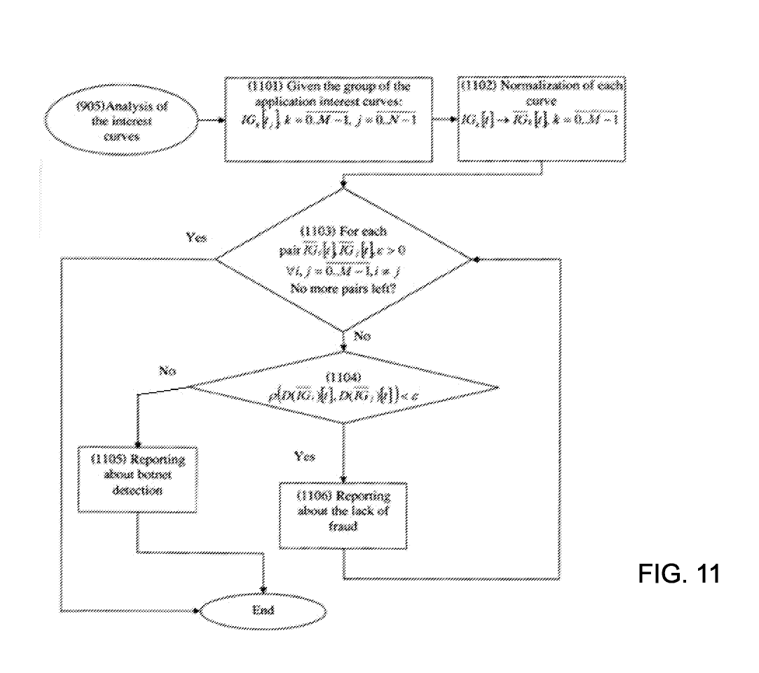

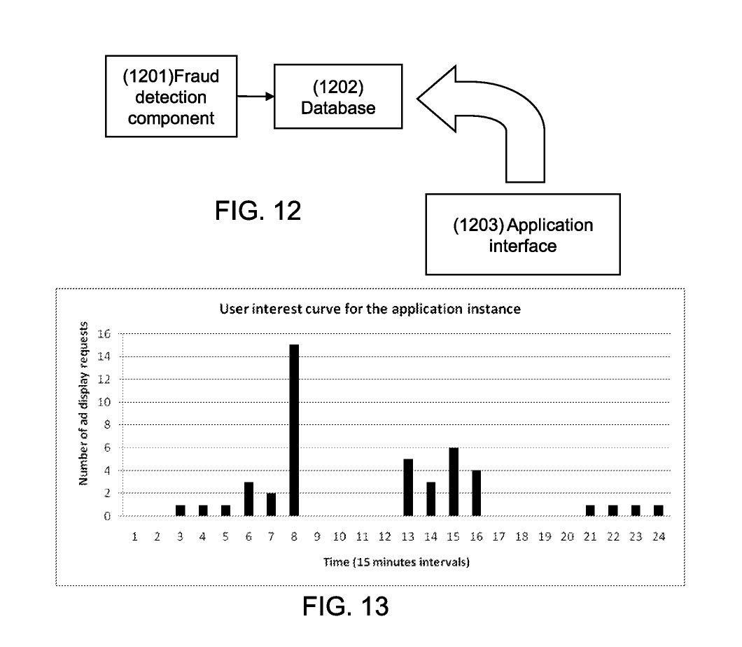

FIG. 11 is a flowchart of an embodiment of a method for analyzing the application interest curve in the WFD component for conformance to the adequate interest model. In embodiments, for each interest curve of the group IGₖ[t], k= 0̅ .̅ .̅ .̅ M̅−̅1̅ normalized curve IGₖ[t]→ I̅G̅ₖ[t], is plotted, the spectrum D( I̅G̅ₖ)[t], k= 0̅ .̅ .̅ .̅ M̅−̅1̅ is calculated, and all spectra are compared to one another. For ε>0∀i, j= 0̅ .̅ .̅ .̅ M̅−̅1̅, i≠j, a check to determine whether ρ(D( I̅G̅ᵢ)[t], D( I̅G̅ⱼ)[t])<ε is carried out. In the event there is such ∃j, that ρ(D( I̅G̅ᵢ)[t], D( I̅G̅ⱼ)[t])≧ε, then the application does not conform to the adequate interest model and will be ignored for ad display.

Estimation of the Number of Bots Among Application Users

In embodiments, the number of bots among the users is estimated by comparing interest curves. One of the interest curves conforms to the adequate interest model (FIGS. 17 and 19) and the other interest curve does not conform to the adequate interest model (FIGS. 18 and 20). Segments where a curve's spectra differ significantly are used to estimate the number of the bots among users. The estimation is based on the interest curve that does not conform to the adequate interest model. The percentage of bots in this segment is the ratio of the frequency burst amplitude to the signal amplitude. FIG. 21 illustrates the process of calculating a number of bots among users, in this case the percentage of bots is computed as A1/A2*100%. In this case, A1 is the amplitude of the frequency burst, A2 is the signal amplitude. In other words, to measure the percentage of bots, the total number of requests in a burst may be determined, which is A2. Then the background number of requests may be subtracted from the total number of bursts, resulting in A1, so that 100*A1/A2 is the percentage of bots/fraudulent requests. As there is no frequency burst with amplitude A1 in the first signal (the signal of FIG. 17), it may be assumed that it originated solely from bots.

In an embodiment of the invention the one or more usage trends (interest curves) can be produced using a multi-resolution wavelet analysis or digital high-pass filters. Further, each usage trend of the one or more usage trends can be compared with at least one other usage trend using a maximum metric or a root-mean-square deviation metric.

### Fraud Prevention System

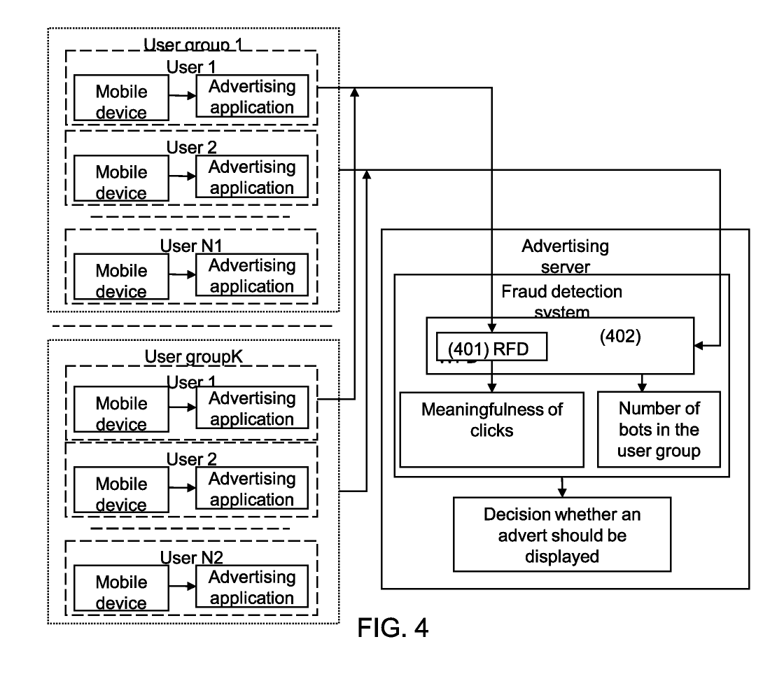

FIG. 4 is a block diagram of an embodiment illustrating mobile device groups interacting with an advertising server configured with fraud detection features. In general, a developer creates an advertising application, registers the advertising application on an advertising server and distributes the advertising application. Users of this application view advertising, and the sponsoring advertiser pays the developer for each ad impression (click, click-through). However, the developer may also create a program to emulate the use of the developer's applications by many users, thus imitating ad impressions (clicks, clickthroughs). Embodiments of the fraud detection portion of the advertising system are configured to identify developers who use ad display imitation and thus fraudulently charge advertisers.

The system of an embodiment in FIG. 4 includes two subsystems—RFD (401) and WFD (402), both of which run in the real-time mode.

The RFD subsystem analyzes individual requests from users, while the WFD subsystem analyzes requests from groups.

An embodiment of the RFD subsystem includes two components—a component for an emulator check of the user's mobile device, and a component for a meaning check of a request (frequent requests from a user are considered to be non-meaningful). In the event the RFD subsystem identifies a mobile device as an emulator or a request is non-meaningful, then the request is considered fraudulent. The amount of fraud from a particular user for a certain period of time (for example, one day) is calculated as the ratio of valid requests to requests regarded as fraudulent. A distribution history of fraudulent requests is recorded into a database.

An embodiment of the WFD subsystem, analyzes requests coming from groups of advertising application users. The WFD component detects a group that demonstrates a behavior different from that of all other groups. In the event a group demonstrates behavior different from other groups, it is an indication that the differing group may contain bots which completely emulate user actions, therefore standard methods of their detection may be ineffective. The WFD subsystem also estimates the number of bots among users. In the event bots are detected in at least one group of application users, the relevant advertising application is ignored for ad display, and the developer of this application is banned, as a large number of bots in the context of mobile advertising in an application is a source of fraud in advertising networks.

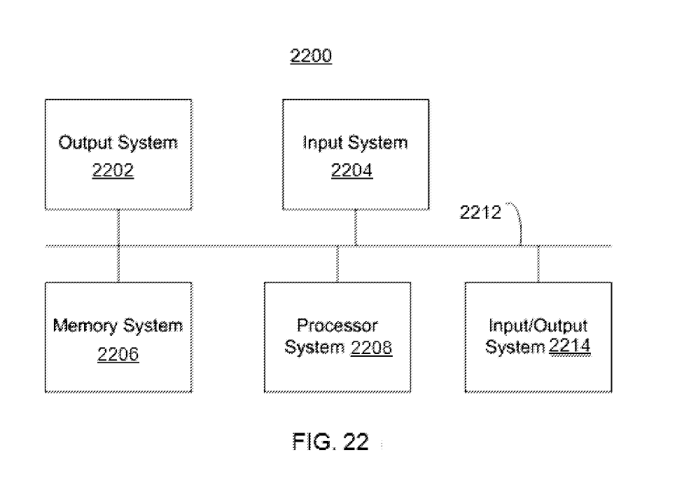

FIG. 22 shows a block diagram of an embodiment of a device2200 used in this specification. The device 2200 may include output system 2202, input system 2204, memory system 2206, processor system 2208, communications system 2212, and input/output device 2214. In other embodiments, device 2200 may include additional components and/or may not include all of the components listed above.

Device 2200 is an example of a device that may be used for a mobile device, server, and/or other devices of this specification.

Output system 2202 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. If device 2200 is a mobile device output system 2202 may include software and/or hardware (e.g., an antenna and transmitter) for wireles sly sending data.

Input system 2204 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. If device 2200 is a mobile device output system 2202 may include software and/or hardware (e.g., an antenna and receiver) for wireles sly sending data.

Memory system 2206 may include, for example, any one of, some of, any combination of, or all of a long term storage system, such as a hard drive; a short term storage system, such as random access memory; a removable storage system, such as a floppy drive or a removable drive; and/or flash memory. Memory system 2206 may include one or more machine-readable mediums in form of a computer program product that may store a variety of different types of information. The term machine-readable medium is used to refer to any medium capable of carrying information that is readable by a machine. One example of a machine-readable medium is a computer-readable medium. The computer program product can carry instructions for carrying out the method of fraud detection described above. If device 2200 is a server, memory system 2206 may store server software and one or more applications for searching for, communicating with, and establishing connections between the other devices of the system. Memory 2206 may store one or more machine instructions for implementing any of the methods described above. If device 2200 is an ad server, memory 2206 may stores interest curves associated with different groups of users and different devices and/or device parameters for a variety of different devices.

Processor system 2208 may include any one of, some of, any combination of, or all of multiple parallel processors, a single processor, a system of processors having one or more central processors and/or one or more specialized processors dedicated to specific tasks. Processor 2208 implements the routines stored is memory 2206.

Communications system 2212 communicatively links output system 2202, input system 2204, memory system 2206, processor system 2208, and/or input/output system 2214 to each other. Communications system 2212 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 2214 may include devices that have the dual function as input and output devices. For example, input/output system 2214 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 2214 is optional, and may be used in addition to or in place of output system 2202 and/or input device 2204. Input output system 2214 may include an antenna and/or other hardware that is used for both sending and receiving messages.

Each embodiment disclosed herein may be used or otherwise combined with any of the other embodiments disclosed. Any element of any embodiment may be used in any embodiment.

While the antifraud method and system has been described by way of example and in terms of the specific embodiments, it is to be understood that the antifraud method and system is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of fraud detection, said method facilitating detection of fraudulent requests from a plurality of content display requests and detection of a source of said fraudulent requests, said plurality of content display requests being received from a plurality of computing devices, said method comprising:
a. maintaining a database of one or more parameters related to at least one of said plurality of computing devices, one or more applications present on said plurality of computing devices, and said content display requests received from said plurality of computing devices corresponding to said one or more applications;
b. grouping said plurality of computing devices into one or more groups, wherein each group of said one or more groups includes one or more computing devices characterized by one or more characteristics;
c. generating one or more usage trends corresponding to usage of a first application on said one or more groups based on at least one parameter from said one or more parameters; and
d. comparing each usage trend of said one or more usage trends with at least one other usage trend of said one or more usage trends for identifying said source of said fraudulent requests.

2. The method of claim 1 further comprising:
a. generating one or more device trends corresponding to said one or more characteristics of a computing device;
b. generating a base device trend corresponding to said one or more characteristics out of said one or more parameters; and
c. comparing said one or more device trends to said base device trend to identify a fraudulent computing device.

3. The method of claim 1, wherein said one or more parameters include a unique identifier of a CPU of a computing device, a unique identifier of a memory card used in a computing device, an IMEI number of a computing device, an IMSI number of a computing device, one or more software component of a computing device, a geographic location of a computing device, an internet provider of a computing device, and a unique identifier of an application.

4. The method of claim 1, wherein said one or more characteristics include a unique identifier of a CPU of a computing device, a unique identifier of a memory card used in a computing device, an IMEI number of a computing device, an IMSI number of a computing device, one or more software component of a computing device, a geographic location of a computing device, and an internet provider of a computing device.

5. The method of claim 1, wherein said one or more usage trends are produced using multi-resolution wavelet analysis.

6. The method of claim 1, wherein said one or more usage trends are produced using digital high-pass filters.

7. The method of claim 1, wherein said comparing of each usage trend of said one or more usage trends with at least one other usage trend of said one or more usage trends is achieved using maximum metric.

8. The method of claim 1, wherein said comparing of each usage trend of said one or more usage trends with at least one other usage trend of said one or more usage trends is achieved using root-mean-square deviation metric.

9. The method of claim 1 further comprising estimating a number of fraudulent requests from said plurality of content display requests.

10. The method of claim 1, wherein said each usage trend of said one or more usage trends is compared to a threshold usage trend for identifying said source of said fraudulent requests.

11. A fraud detection system for detection of fraudulent requests from a plurality of content display requests and detection of a source of said fraudulent requests, said plurality of content display requests being received from a plurality of computing devices, said fraud detection system comprising:
a. a memory module, said memory module including a database of one or more parameters related to at least one of said plurality of computing devices, one or more applications present on said plurality of computing devices, and said content display requests received from said plurality of computing devices corresponding to said one or more applications;
b. a grouping module, said grouping module grouping said plurality of computing devices into one or more groups, wherein each group of said one or more groups includes one or more computing devices characterized by one or more characteristics; and
c. a processor, said processor configured to:
i. generate one or more usage trends corresponding to usage of a first application on said one or more groups based on at least one parameter from said one or more parameters; and
ii. compare each usage trend of said one or more usage trends with at least one other usage trend of said one or more usage trends for identifying said source of said fraudulent requests.

12. The fraud detection system of claim 11, wherein said processor is further configured to:
a. generate one or more device trends corresponding to said one or more characteristics of a computing device;
b. generate a base device trend corresponding to said one or more characteristics out of said one or more parameters; and
c. compare said one or more device trends to said base device trend to identify a fraudulent computing device.

13. The fraud detection system of claim 11, wherein said one or more parameters include a unique identifier of a CPU of a computing device, a unique identifier of a memory card used in a computing device, an IMEI number of a computing device, an IMSI number of a computing device, one or more software component of a computing device, a geographic location of a computing device, an internet provider of a computing device, and a unique identifier of an application.

14. The fraud detection system of claim 11, wherein said one or more characteristics include a unique identifier of a CPU of a computing device, a unique identifier of a memory card used in a computing device, an IMEI number of a computing device, an IMSI number of a computing device, one or more software component of a computing device, a geographic location of a computing device, and an internet provider of a computing device.

15. The fraud detection system of claim 11, wherein said one or more usage trends are produced using multi-resolution wavelet analysis.

16. The fraud detection system of claim 11, wherein said one or more usage trends are produced using digital high-pass filters.

17. The fraud detection system of claim 11, wherein said processor compares each usage trend of said one or more usage trends with at least one other usage trend of said one or more usage trends by using maximum metric.

18. The fraud detection system of claim 11, wherein said processor compares each usage trend of said one or more usage trends with at least one other usage trend of said one or more usage trends by using root-mean-square deviation metric.

19. The fraud detection system of claim 11, wherein said processor is further configured to estimate a number of fraudulent requests from said plurality of content display requests.

20. The fraud detection system of claim 11, wherein said processor compares each usage trend of said one or more usage trends to a threshold usage trend for identifying said source of said fraudulent requests.

21. A computer program product for use in fraud detection, said computer program product facilitating detection of fraudulent requests from a plurality of content display requests and detection of a source of said fraudulent requests, said computer program product comprising at least one computer-readable storage medium having computer-readable program code portions stored therein, said computer-readable program code portions comprising instructions for:
a. maintaining a database of one or more parameters related to at least one of said plurality of computing devices, one or more applications present on said plurality of computing devices, and said content display requests received from said plurality of computing devices corresponding to said one or more applications;
b. grouping said plurality of computing devices into one or more groups, wherein each group of said one or more groups includes one or more computing devices characterized by one or more characteristics;
c. generating one or more usage trends corresponding to usage of a first application on said one or more groups based on at least one parameter from said one or more parameters; and
d. comparing each usage trend of said one or more usage trends with at least one other usage trend of said one or more usage trends for identifying said source of said fraudulent requests.

22. The computer program product of claim 21 comprising further instructions for:
a. generating one or more device trends corresponding to said one or more characteristics of a computing device;
b. generating a base device trend corresponding to said one or more characteristics out of said one or more parameters; and
c. comparing said one or more device trends to said base device trend to identify a fraudulent computing device.

23. The computer program product of claim 21, wherein said one or more parameters include a unique identifier of a CPU of a computing device, a unique identifier of a memory card used in a computing device, an IMEI number of a computing device, an IMSI number of a computing device, one or more software component of a computing device, a geographic location of a computing device, an internet provider of a computing device, and a unique identifier of an application.

24. The computer program product of claim 21, wherein said one or more characteristics include a unique identifier of a CPU of a computing device, a unique identifier of a memory card used in a computing device, an IMEI number of a computing device, an IMSI number of a computing device, one or more software component of a computing device, a geographic location of a computing device, and an internet provider of a computing device.

25. The computer program product of claim 21, wherein said one or more usage trends are produced using multi-resolution wavelet analysis.

26. The computer program product of claim 21, wherein said one or more usage trends are produced using digital high-pass filters.

27. The computer program product of claim 21, wherein said comparing of each usage trend of said one or more usage trends with at least one other usage trend of said one or more usage trends is achieved using maximum metric.

28. The computer program product of claim 21, wherein said comparing of each usage trend of said one or more usage trends with at least one other usage trend of said one or more usage trends is achieved using root-mean-square deviation metric.

29. The computer program product of claim 21 further comprising estimating a number of fraudulent requests from said plurality of content display requests.

30. The computer program product of claim 21, wherein said each usage trend of said one or more usage trends is compared to a threshold usage trend for identifying said source of said fraudulent requests.
